(19) United States
(12) Patent Application Publication
(10) Pub. No.: US 2014/0368499 A1
(43) Pub. Date: Dec. 18, 2014

(54) Virtual Fitting Room

(71) Applicant: Rajdeep Kaur, Warren, NJ (US)

(72) Inventor: Rajdeep Kaur, Warren, NJ (US)

(21) Appl. No.: 13/918,942

(22) Filed: Jun. 15, 2013

(51) Int. Cl. G06T 19/00; G06T 17/00

(52) U.S. Cl. CPC G06T 19/006; G06T 17/00
USPC 345/420

(57) ABSTRACT

A virtual fitting room application is described that allows an individual to digitally try out different apparel on a customized graphical three-dimensional model before the individual potentially purchases the apparel. A user interface device of a computer executing the virtual fitting room application can receive values of multiple parameters characterizing dimensions associated with corresponding portions of a body. A server system connected to the computer can use the values of those parameters to generate the graphical three-dimensional model specific to the body. The user interface device can receive data identifying an apparel selected from a plurality of apparel. The server system can fit, based on the data identifying the apparel, the apparel on the graphical three-dimensional model to generate a clad three-dimensional model. The user interface device can display the clad three-dimensional model along with options to purchase the selected apparel.

### TECHNICAL FIELD

The subject matter described herein relates to a virtual fitting room application that allows an individual to digitally try out different apparel on a graphical three-dimensional model generated based on respective body parameters specified by the individual before the individual potentially purchases the apparel.

### BACKGROUND

Online shopping can require less physical movement than shopping in distant physical stores, where a shopper typically moves long distances from store to store. Additionally, online shopping can provide better prices and more variety of apparel for shopping as compared to those for apparel sold by the physical stores. However, although online shopping provides many advantages, it currently suffers from a major drawback that shoppers do not know whether a particular apparel that fits well on a standard mannequin will fit their specific body. Often, the shoppers order online an apparel that fits well on a standard mannequin, but does not fit properly on the body of the shopper. Due to this major drawback, the shoppers return the ordered apparel to the online merchant. Such a return of previously bought apparel not only results in possible extra shipping fees and wasted time of those shoppers, but also creates a disloyalty amongst those shoppers. This can cause a significant loss of customers as well as revenue for online merchants selling the apparel.

### SUMMARY

The current subject matter describes a virtual fitting room application that allows an individual to digitally try out different apparel on a graphical three-dimensional model generated based on respective body parameters specified by the individual before the individual potentially purchases the apparel. Related methods, apparatuses, systems, techniques, and articles are also described.

In one aspect, values of a plurality of parameters characterizing dimensions associated with corresponding portions of a body can be received at a user interface device of a computer. The values of the plurality of parameters can be used by a server system connected to the computer to generate a graphical three-dimensional model specific to the body. At the user interface device, data identifying an apparel selected from a plurality of apparel can be received. The data identifying the apparel can be used by the server system to fit the apparel on the graphical three-dimensional model to generate a clad three-dimensional model. The user interface device can then display the clad three-dimensional model.

In some variations, one or more of the following can be additionally implemented either individually or in any suitable combination. The plurality of parameters can include two or more of: gender, height, size of chest, size of waist, size of hips, skin-tone, color of hair, style of hair, size of tummy, circumference of neck, length from shoulder to wrist, length from shoulder to elbow, length from elbow to wrist, length from hips to feet, length from hips to knees, length from knees to feet, length of left foot, length of right foot, width of left foot, and width of right foot. The computer can be connected to the server system via a communication network. The communication network can be internet.

Furthermore, the generating of the graphical three-dimensional model can include: obtaining, by the server system, a three-dimensional mesh characterizing a basic structure of a human body; and modifying, by the server system and based on the values of the plurality of parameters, paths of at least a few lines of the three-dimensional mesh to generate a refined three-dimensional mesh characterizing the graphical three-dimensional model.

Further, the generating of the clad three-dimensional model can include: graphically superimposing, by the server system and based on a first set of fitting data associated with the selected apparel, the selected apparel on the graphical three-dimensional model; and modifying, by the server system and based on a second set of fitting data associated with the selected apparel, paths of one or more lines of a refined three-dimensional mesh characterizing the graphical three-dimensional model to shapely-fit the selected apparel on the graphical three-dimensional model to generate the clad three-dimensional model.

In one variation, the first set of fitting data can include basic fitting data that indicates a shape of the selected apparel. The second set of fitting data can include fitting data that is used for a shapely fit specific to the graphical three-dimensional model.

In further variations, the user interface device can receive an input to rotate the graphical three-dimensional model along a displayed axis. One of the computer and the server system can rotate the graphical three-dimensional model along the displayed axis based on the input. The user interface device can display the rotated graphical three-dimensional model. In another variation, the user interface device can receive an input to scale the graphical three-dimensional model. One of the computer and the server system can scale the graphical three-dimensional model based on the input. The user interface device can display the scaled graphical three-dimensional model.

In some variations, the user interface device can receive an input to rotate the clad graphical three-dimensional model along a displayed axis. One of the computer and the server system can rotate the clad three-dimensional model along the displayed axis based on the input. The user interface device can display the rotated clad three-dimensional model. In another variation, the user interface device can receive an input to scale the clad three-dimensional model. One of the computer and the server system can scale the clad three-dimensional model based on the input. The user interface device can display the scaled clad three-dimensional model.

In further variations, the user interface device can receive a selection of a video button displayed along with the clad three-dimensional model. The user interface device can receive a video generated by the server system. The video can characterize a graphical movement of the clad-three dimensional model. The graphical movement of the clad-three-dimensional model can characterize at least one of a graphical walking and a graphical running of the clad-three-dimensional model.

In another variation, the computer can receive a photograph of an individual associated with the body. The photograph of the individual can be used by the server system to digitally sculpt a face of the clad three-dimensional model. The user interface device can display the clad-three dimensional model with the sculpted face. The computer can receive the photograph either when an individual using the computer uploads the photograph that is pre-stored in a memory device of the computer or when a camera embedded in the computer clicks the photograph of an individual using the computer. The sculpting of the face of the clad-three dimensional model can include: modifying, by the central computing system and based on a face in the photograph, paths of specific lines of a facial portion of a refined three-dimensional mesh characterizing the graphical three-dimensional model to generate the sculpted face.

In a further variation, the user interface device can receive a selection of a share button displayed along with the clad three-dimensional model. The computer can share, after the selection of the share button is received, the clad three-dimensional model via at least one of: at least one email, at least one blog, an internal computing site of a company, one or more social networks, and a publishing location on internet.

Computer program products are also described that comprise non-transitory computer readable media storing instructions, which when executed by at least one data processors of one or more computing systems, causes at least one data processor to perform operations described herein. Further, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the virtual fitting room application allows an individual to digitally try on apparel on a graphical three-dimensional model that is generated based on specific dimensions provided by the individual. This trying of the apparel allows the individual to determine/judge whether the apparel fits the body of the wearer of the apparel in a desired way. Such satisfaction of the fit of the apparel before purchasing the apparel can prevent a return of the purchased apparel based on a misfit, thereby preventing wastage of time of the individual. Additionally, the virtual fitting room application can simulate a real environment of shopping in physical stores by initially graphically displaying apparel in a graphical wardrobe, which can characterize a wardrobe in a physical store. Such a simulated environment can make the shopping experience satisfactory, realistic and enjoyable for the individual. The prevention of loss of time of the individual along with a satisfactory, realistic and enjoyable shopping experience can lead to a loyalty of the individual towards the merchant that sells apparel on the virtual fitting room application. This can result in a significant increase in revenue for such merchants.

The details of one or more variations of the subject matter described herein are set forth in the accompanying drawings and the description below. Other features and advantages of the subject matter described herein will be apparent from the description, the drawings, and the claims.

### DESCRIPTION OF DRAWINGS

FIG. 1 is a system diagram illustrating execution of a virtual fitting room application;

FIG. 2 is a diagram illustrating a graphical user interface executed by the virtual fitting room application to receive values of parameters used to generate a three-dimensional model specific for requirements of the individual;

FIG. 3 is a diagram illustrating a graphical user interface executed by the virtual fitting room application to display a three-dimensional model generated based on values of parameters specified by the individual;

FIG. 4 is a diagram illustrating a graphical user interface executed by the virtual fitting room application where the individual has rotated the three-dimensional model in a particular direction along an axis;

FIG. 5 is a flow-diagram illustrating a method of displaying a three-dimensional model on a graphical user interface executed by the virtual fitting room application;

FIG. 6 is a diagram illustrating a generation of three-dimensional model specific to values of parameters specified by an individual;

FIG. 7 is a flow-diagram illustrating a generation of three-dimensional model specific to values of parameters specified by an individual;

FIG. 8 is a flow-diagram illustrating an alternative generation of three-dimensional model specific to values of parameters specified by an individual;

FIG. 9 is an alternative system diagram illustrating execution of a virtual fitting room application;

FIG. 10 is a diagram illustrating an alternate graphical user interface 1002 executed by the virtual fitting room application to receive values of parameters used to generate a three-dimensional model specific for requirements of the individual;

FIG. 11 is a diagram illustrating a graphical user interface executed by the virtual fitting room application to display a three-dimensional model generated based on values of parameters specified by the individual;

FIG. 12 is a diagram illustrating a graphical user interface executed by the virtual fitting room application to allow the individual to specify values for search criteria used for searching apparel;

FIG. 13 is a diagram illustrating a graphical user interface executed by the virtual fitting room application to display search results characterizing apparel that are searched and displayed based on values of search criteria specified by the individual;

FIG. 14 is a diagram illustrating a graphical user interface executed by the virtual fitting room application to try on selected apparel on the graphical three-dimensional model;

FIG. 15 is a flow-diagram illustrating a fitting of a selected apparel on the three-dimensional model to generate a clad three-dimensional model;

FIG. 16 is a diagram illustrating a graphical user interface executed by the virtual fitting room application to try on another selected apparel on the graphical three-dimensional model;

FIG. 17 is a diagram illustrating a graphical user interface that provides a button, which, when clicked, displays a video of the clad three-dimensional model; and

FIG. 18 is a flow-diagram illustrating a method of displaying a clad three-dimensional model having a face that is sculpted in accordance with facial features of a wearer of the selected apparel.

Like reference symbols in the various drawings indicate like elements.

### DETAILED DESCRIPTION

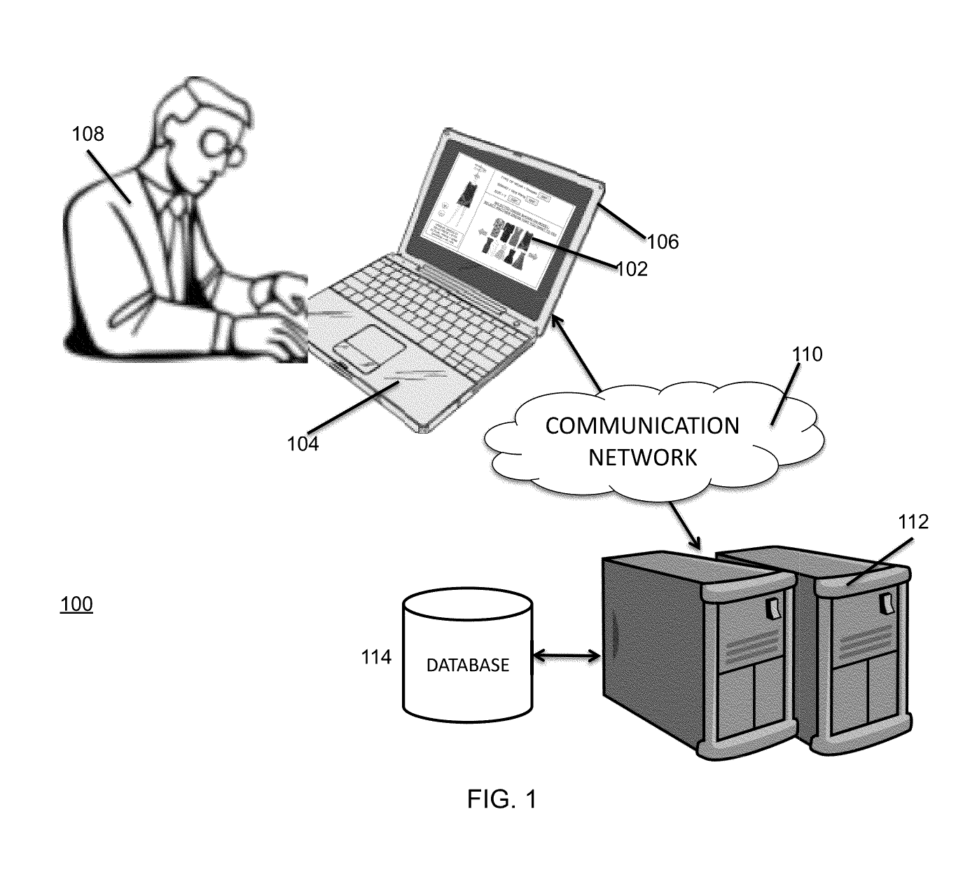

FIG. 1 is a system diagram 100 illustrating execution of a virtual fitting room application 102. A computer 104 can execute the virtual fitting room application 102 and can display the virtual fitting room application 102 on a user interface device 106 of the computer 104. An individual 108, such as a shopper, can use the virtual fitting room application 102 by using the computer 104. A communication network 110 can connect the computer 104 with a central server system 112. The computer 104 and the central server system 112 can form a client-server system where the computer 104 and other such computers form a client system and the central server system 112 forms a server system. The central server system 112 can be connected to a database 114 by either a wired connection or a wireless connection via another communication network. Although the database 114 is described as separate from the central server system 112, in another implementation, the database 114 can be embedded within the central server system 112.

The virtual fitting room application 102 is described in more detail further below.

The computer 104 can include a desktop computer, a laptop computer, a tablet computer, a cellular phone, and any other computer. Although a single computer 104 is described to execute the virtual fitting room application 102, in another implementation, a distributed computing landscape including multiple connected computers can execute the virtual fitting room application 102 in an enterprise resource planning environment. The computer 104 can allow the individual 108 to input or specify data via a keyboard, a mouse, a trackball, a joystick, a touch-screen, or any other input device. The user interface device 106 can be a display device, such as a cathode ray tube (CRT) device, a liquid crystal display (LCD) monitor, a light emitting diode (LED) monitor, or any other display device.

The individual 108 can be a shopper who may have an intention to purchase apparel from a merchant selling products using the virtual fitting room application 102. The individual 108 can also be referred to as a shopper, an entity, a person, a human being, a user, or an automated system in different implementations.

The communication network 110 can be at least one of: a wired network, a local area network, a wide area network, internet, intranet, Bluetooth network, infrared network, and any other communication network.

The central server system 112 can serve as a server for a plurality of clients including the computer 104. The central server system 112 can include at least one computer that includes one or more data processors, and a memory/database, which can be either same or different from the database 114. In one implementation, the central server system 112 can be a cloud computing system. In another implementation, the central server system 112 can be one or more of: an application server, a catalog server, a communications server, a carrier grade server, a database server, a home server, a mobile server, a web server, a proxy server, or any other system.

The database 114 can be one of: a flat file database, a hierarchical database, a network database, an in-memory relational database, and any other database.

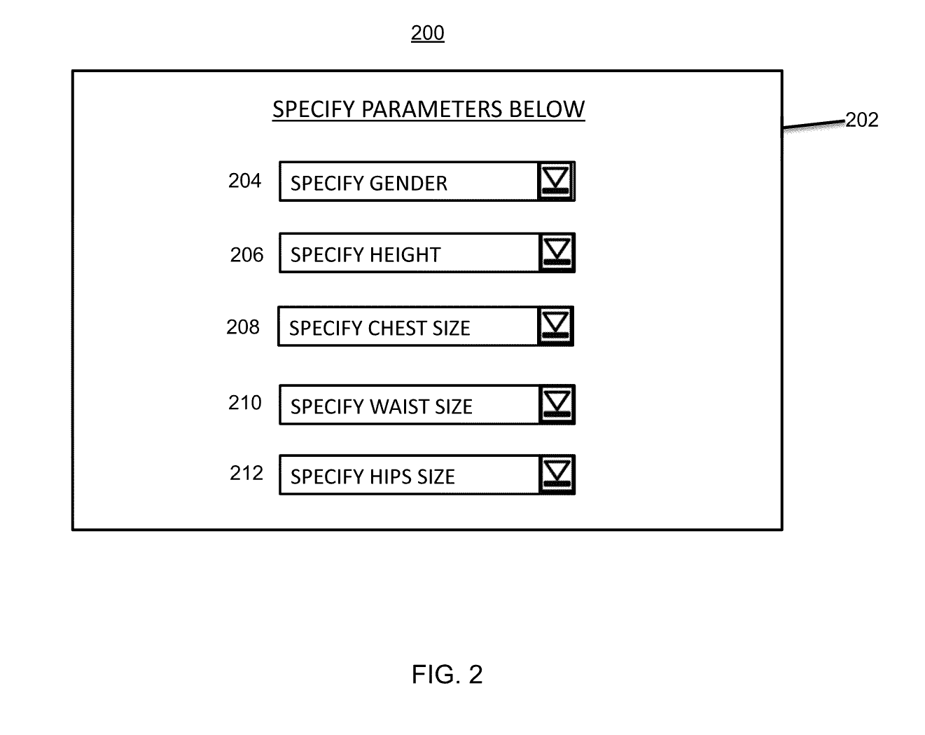

FIG. 2 is a diagram 200 illustrating a graphical user interface 202 executed by the virtual fitting room application 102 to receive values of parameters used to generate a three-dimensional model specific for requirements of the individual 108. The parameters can include gender, height, size (for example, circumference) of chest, size (for example, circumference) of waist, and size (for example, circumference) of hips. The circumference of a body-part can refer to a circumference of the human body around the body-part such that the circumference is in a direction perpendicular to direction of height of the body.

The graphical user interface 202 can include a drop down menu 204 for specifying gender, a drop down menu 206 for specifying height, a drop down menu 208 for specifying size of chest, a drop down menu 210 for specifying size of waist, and a drop down menu 212 for specifying size of hips. The graphical user interface 202 can allow the individual 108 to use the drop down menus 204, 206, 208, and 210 to select values of corresponding parameters from respective drop-down lists.

Gender can be one of male and female. Height can be in feet and inches or in meters and centimeters. Size of chest, size of waist, and size of hips can be specified in inches, centimeters, and/or any other unit. Each drop-down list can have any corresponding predetermined number of pre-populated values, from which the individual 108 can select one value. In an alternate implementation, the graphical user interface 202 can allow the individual 108 to select one or more values from any pre-populated drop-down list.

Although the graphical user interface 202 is described as allowing the individual 108 to select values of parameters from pre-populated drop-down lists, in some another implementations, the graphical user interface can allow the individual 108 to specify customized values of the parameters in blank spaces.

The graphical user interface 202 can necessitate input for specifying at least one parameter of all the displayed parameters so as to generate a three-dimensional model. In another implementation, the graphical user interface 202 can require input for all the displayed parameters to generate the three-dimensional model.

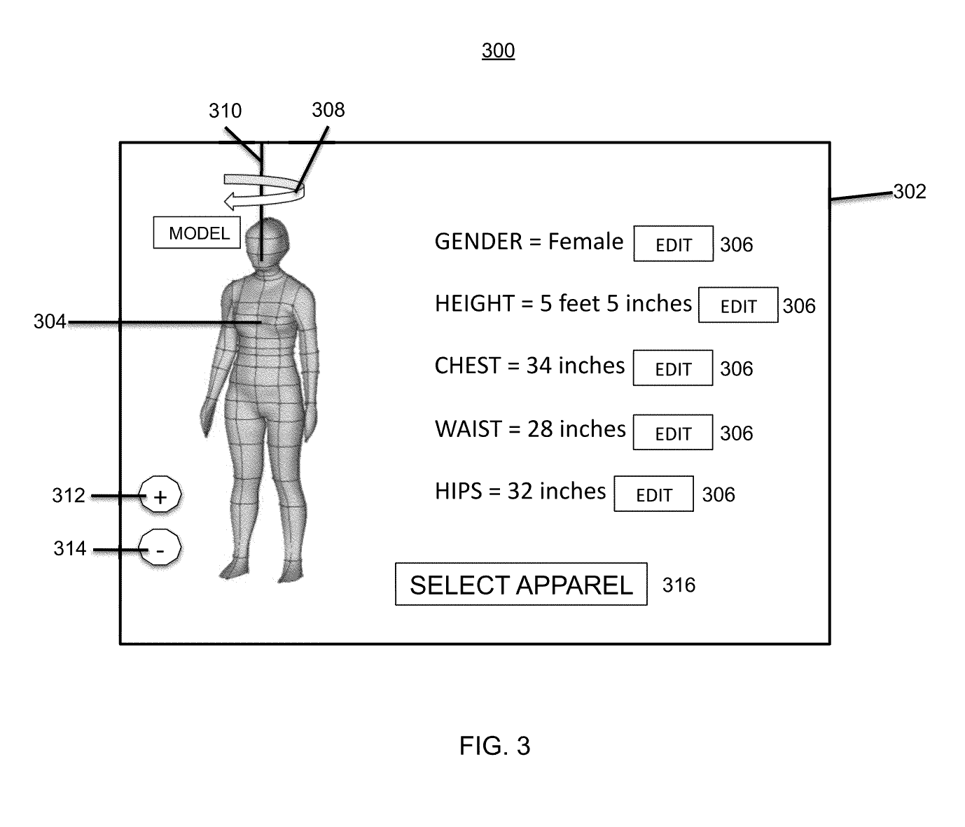

FIG. 3 is a diagram 300 illustrating a graphical user interface 302 executed by the virtual fitting room application 102 to display a three-dimensional model 304 generated based on values of parameters specified by the individual 108. The generation of the three-dimensional model 304 is described further below. The graphical user interface 302 can display the values of the parameters, which can be selected by the individual 108 by using the drop-down menus 204, 206, 208, 210, and 212. The graphical user interface 302 can provide an edit button 306 next to the value of each parameter. The graphical user interface 302 can allow the individual 108 to edit/modify a value of any parameter by selection/clicking-on the edit button 306. When the individual 108 selects the edit button 306 and provides a new value of the associated parameter, the three-dimensional model 304 can be modified (for example, refined again) based on the edited value of the parameter. In other implementations, the three-dimensional model 304 can be regenerated when the individual 108 provides a new value of the associated parameter.

The graphical user interface 302 can allow the individual 108 to rotate the three-dimensional model 304 in a particular direction 308 around an axis 310. Although the direction 308 is described, in other implementations, the graphical user interface 302 can allow the individual 108 to rotate the three-dimensional model 304 in any direction. In some implementations, the graphical user interface 302 can allow the individual 108 to modify the direction of the axis 310 as desired by the individual 108. The graphical user interface 302 can allow the individual 108 to rotate the three-dimensional model 304 and/or modify the axis 310 by using touch on a touch-screen, a stylus, a mouse, and/or any other input device.

The graphical user interface 302 can further allow the individual 108 to vary a scale of the three-dimensional model 304 by using a zoom-in button 312 and a zoom-out button 314. In some implementations, the graphical user interface 302 can also allow the individual 108 to graphically modify the three-dimensional model 304 by directly changing boundaries (for example, changing locations of one or more boundary paths or lines) of the three-dimensional model 304 by using a graphical drawing tool, such as a graphical pencil or a stylus optionally provided by the graphical user interface 302. The three-dimensional model 304 can be modified in any rotation and scaling position of the three-dimensional model 304.

The graphical user interface 302 can further include a button 316. When the individual 108 clicks the button 316, the virtual fitting room application 102 can execute another graphical user interface 1202 (described below) that can allow the individual 108 to specify search criteria to search for apparel. Once the individual 108 specifies values for the search criteria, the virtual fitting room application 102 can execute another graphical user interface 1302 (described below) that can display the available apparel based on values of the search criteria specified by the individual 108 on the graphical user interface 1202.

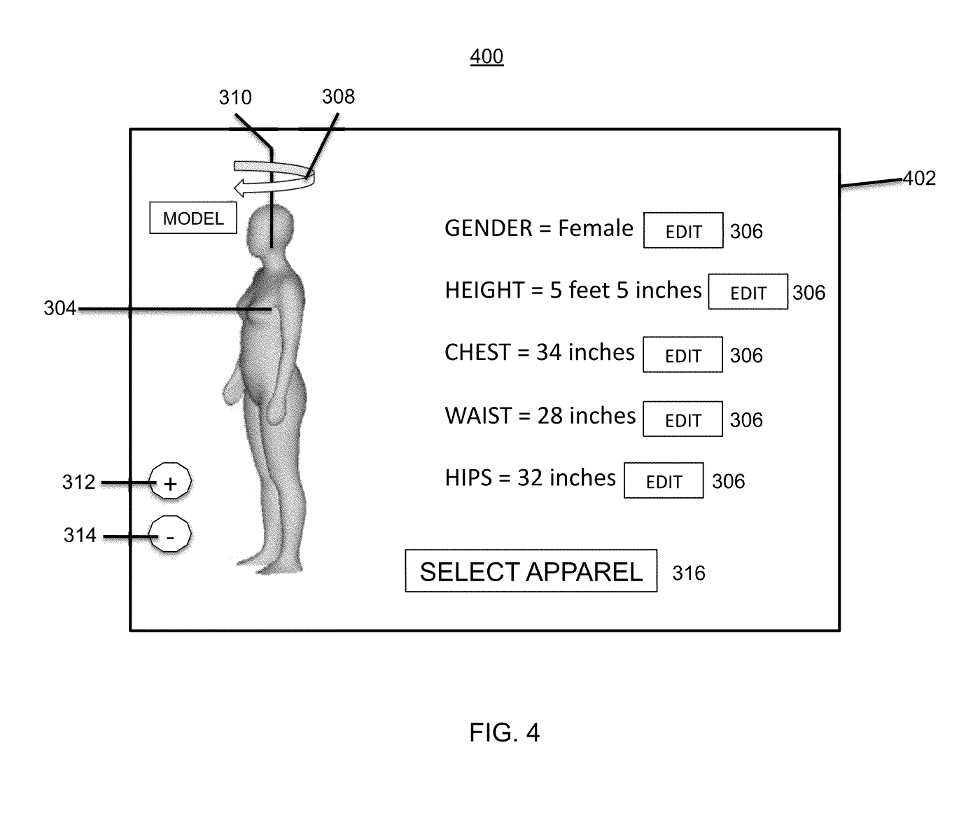

FIG. 4 is a diagram 400 illustrating a graphical user interface 402 executed by the virtual fitting room application where the individual 108 has rotated the three-dimensional model in a particular direction 308 along an axis 310.

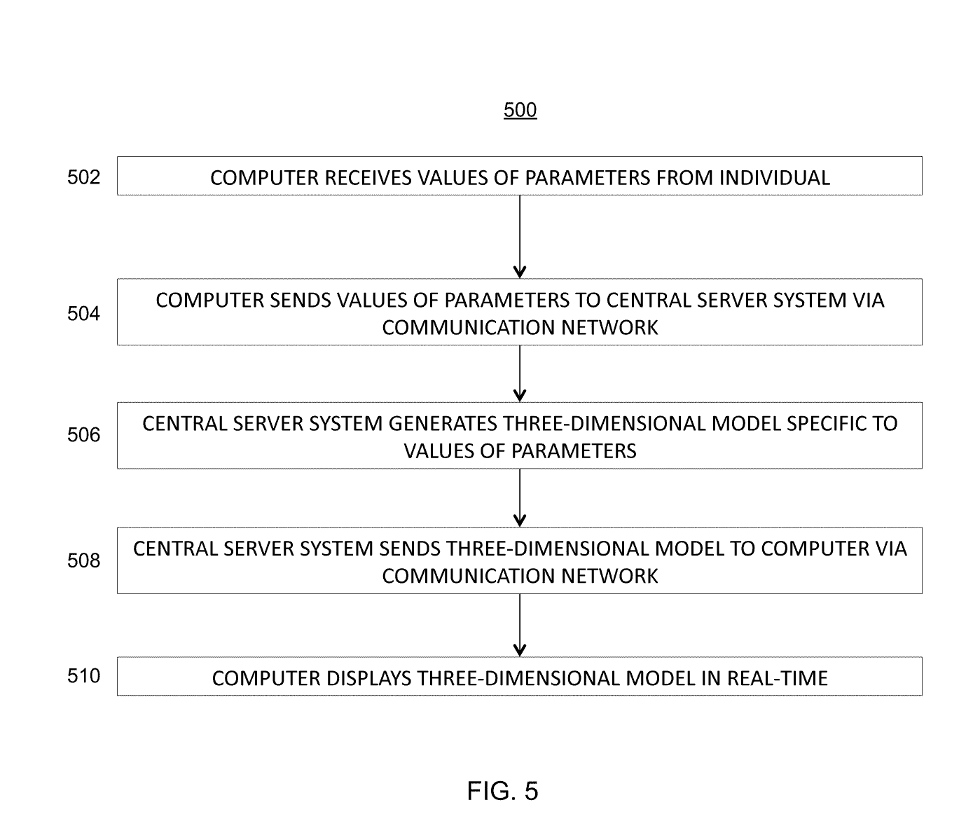

FIG. 5 is a flow-diagram 500 illustrating a method of displaying a three-dimensional model 304 on a graphical user interface 302 executed by the virtual fitting room application 102. The graphical user interface 202 can receive, at 502, values of parameters from an individual 108. These parameters can characterize at least a basic body-structure specific to the parameters. These parameters can include at least one of: gender, height, size of chest, size of waist, and size of hips.

The computer 104 executing the virtual fitting room application 102 can send, at 504, the received values of parameters to the central server system 112 via a communication network 110. The server can generate, at 506, a three-dimensional model 304 specific to the values of the parameters specified by the individual 108. The central server system 112 can send, at 508, the three-dimensional model 304 to the computer 104. The computer 104 can display the three-dimensional model 304 on the graphical user interface 302 in real-time. That is, the three-dimensional model 304 can be generated and displayed within minimal or no lag time (for example, within any value less than two seconds or less) since specification of values of parameters by the individual 108.

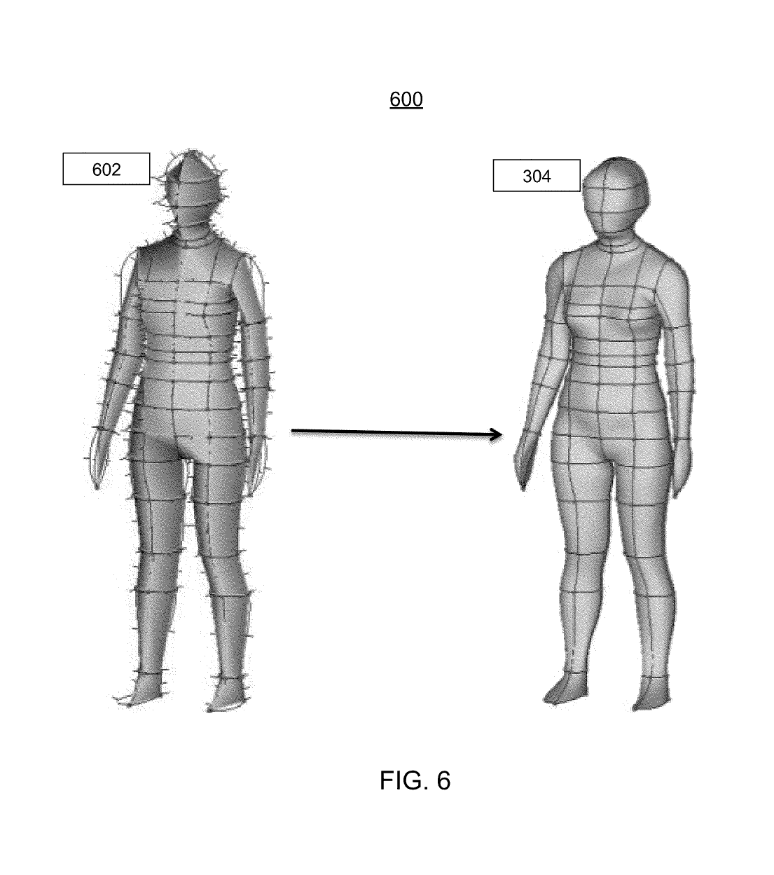

FIG. 6 is a diagram 600 illustrating a generation of three-dimensional model 304 specific to values of parameters specified by an individual 108. The central server system 112 can obtain a pre-stored three-dimensional mesh 602 from the database 114. In one implementation, the pre-stored three-dimensional mesh 602 can be specific for a male and a female, and can be obtained from the database based on the gender specified by the individual 108 on graphical user interface 202. Based on other parameters, such as height, size of chest, size of waist, and size of hips, the central server system 112 can vary specific lines of the three-dimensional mesh 602 to generate a refined three-dimensional mesh characterizing the three-dimensional model 304. In one example, these specific lines can be mesh lines along the chest, waist, hips, and/or any other body-part associated with the parameters specified by the individual 108. In some implementations, these specific mesh lines can be predetermined lines, such as particular lines along body-parts associated with parameters specified by the individual 108. The variation in length of each of these specific lines can be directly proportional to a difference between circumference covered by a respective line in the three-dimensional model 304 and corresponding circumference in the three-dimensional mesh 602.

In an alternate implementation, the three-dimensional mesh 602 can be same for both a male and a female regardless of the gender specified by the individual 108. Subsequently, the central server system 112 can generate a refined three-dimensional mesh characterizing the three-dimensional model 304 based on all parameters, such as gender, height, size of chest, size of waist, and size of hips, as specified by the individual 108.

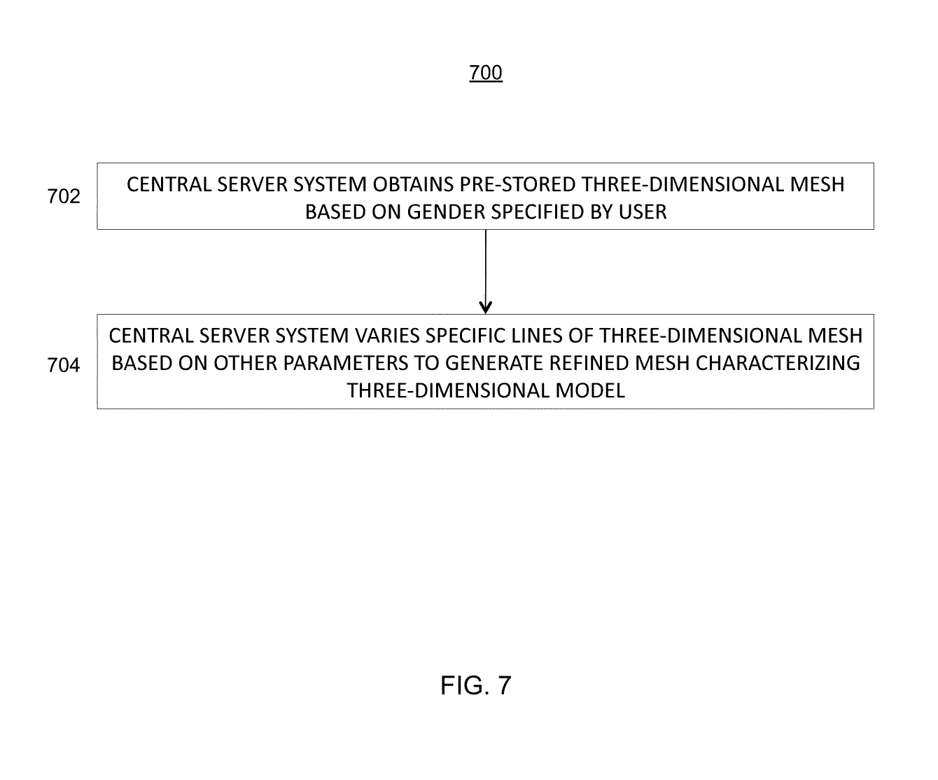

FIG. 7 is a flow-diagram 700 illustrating a generation of three-dimensional model 304 specific to values of parameters specified by an individual 108. The central server system 112 can obtain, at 702 and based on gender specified by the individual 108 on graphical user interface 202, a pre-stored three-dimensional mesh 602 from the database 114. Based on other parameters, such as height, size of chest, size of waist, and size of hips, the central server system 112 can vary specific (for example, predetermined) lines of the three-dimensional mesh 602 to generate, at 704, the three-dimensional model 304.

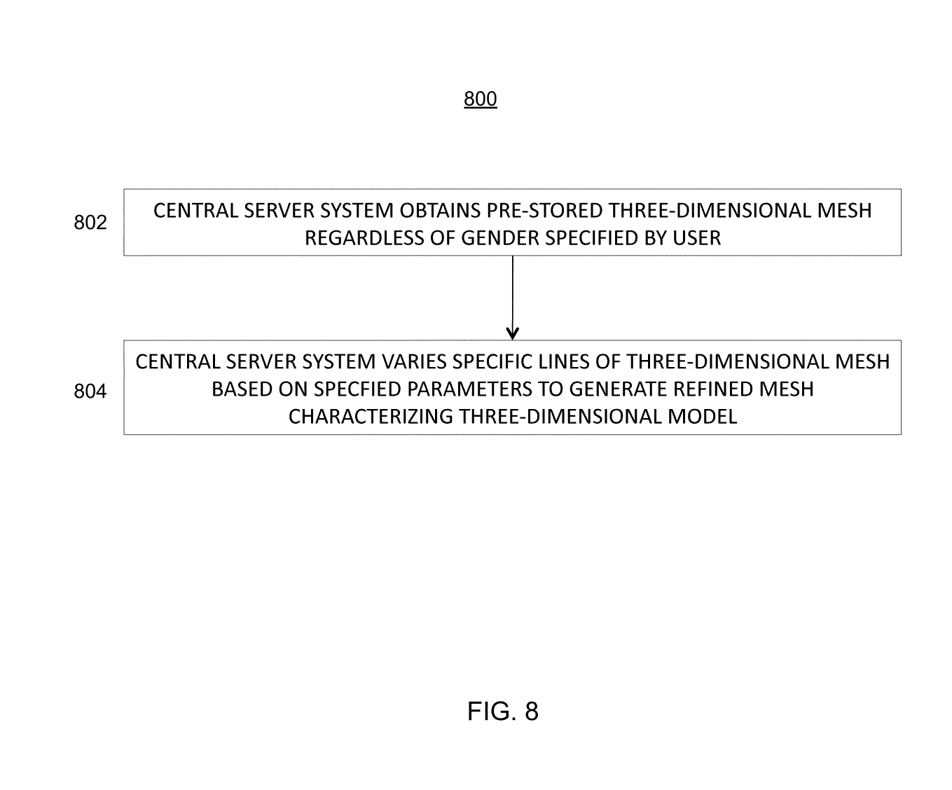

FIG. 8 is a flow-diagram 800 illustrating an alternative generation of three-dimensional model 304 specific to values of parameters specified by an individual 108. The central server system 112 can obtain, at 802, a pre-stored three-dimensional mesh 602 from the database 114. In this implementation, the three-dimensional mesh 602 can be same for both male and female regardless of gender specified by the individual 108. Based on parameters, such as gender, height, size of chest, size of waist, and size of hips, the central server system 112 can vary specific (for example, predetermined) lines of the three-dimensional mesh 602 to generate, at 704, the three-dimensional model 304.

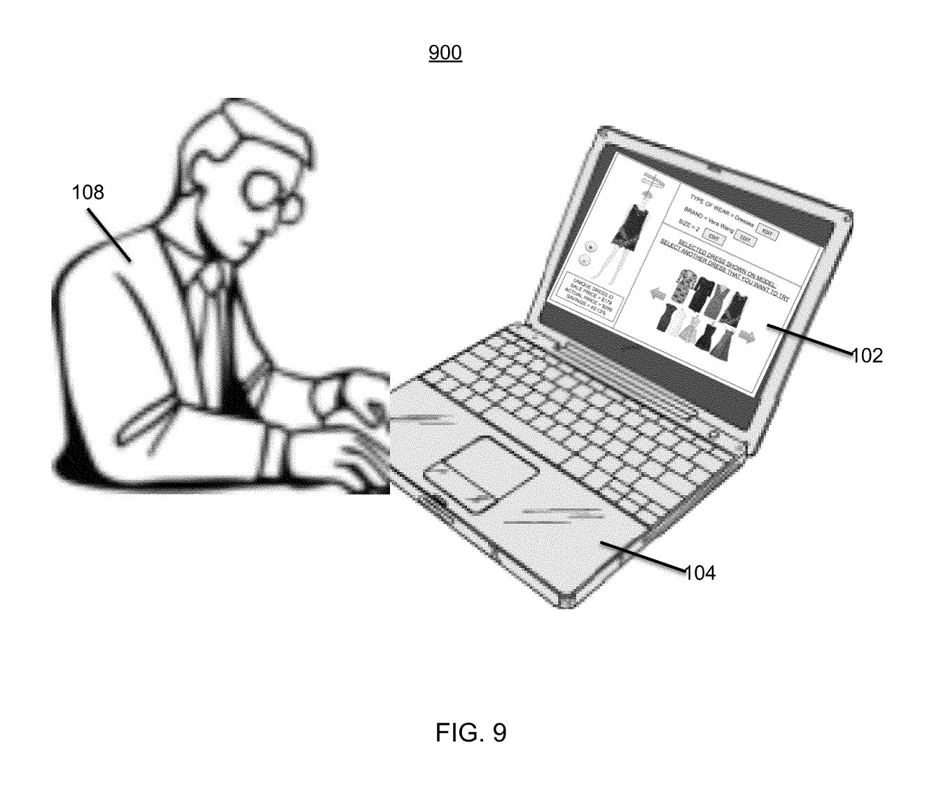

FIG. 9 is an alternative system diagram 900 illustrating execution of a virtual fitting room application 102. More specifically, the system diagram 900 can be one alternate to system diagram 100 for executing the virtual fitting room application 102. In the system diagram 900, a server system and database performing operations of the central server system 112 and the database 114, respectively, can be embedded within the computer 104. This embedded server system can include one or more data processors and a memory to perform operations that are otherwise performed by the central server system 112. The system diagram 900 can allow for potential manufacturing of computing devices that can be manufactured specifically for the virtual fitting room application.

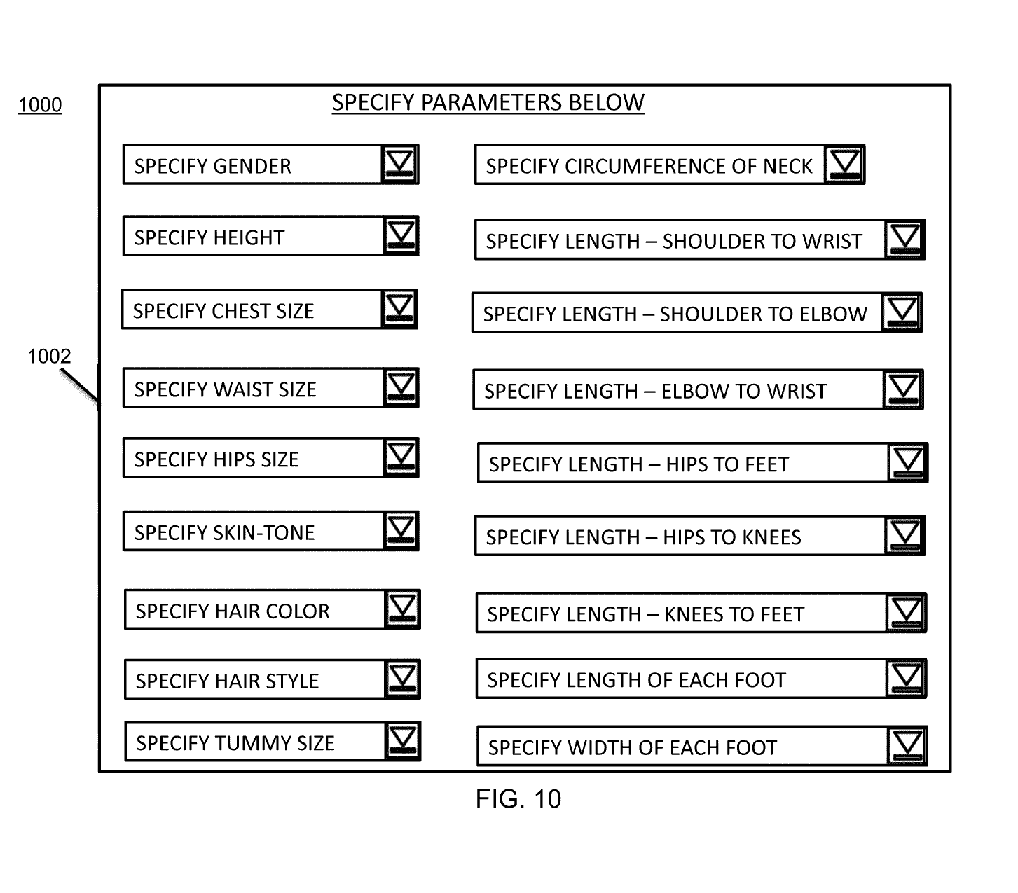

FIG. 10 is a diagram 1000 illustrating an alternate graphical user interface 1002 executed by the virtual fitting room application 102 to receive values of parameters used to generate a three-dimensional model specific for requirements of the individual 108. The graphical user interface 1002 can be an alternate to the graphical user interface 202. The parameters can include one or more of: gender, height, size (for example, circumference) of chest, size (for example, circumference) of waist, size (for example, circumference) of hips, skin-tone, color of hair, style of hair, size (for example, circumference) of tummy, circumference of neck, length from shoulder to wrist, length from shoulder to elbow, length from elbow to wrist, length from hips to feet, length from hips to knees, length from knees to feet, length of left foot, length of right foot, width of left foot, width of right foot, and any other parameter. The circumference, herein, of a body-part can refer to a circumference of the human body around the body-part such that the circumference is in a direction perpendicular to direction of height of the body.

The graphical user interface 1002 can include a drop down menu for specifying values of one or more of the above-mentioned parameters. The graphical user interface 1002 can necessitate input of some parameters by the individual 108 while having input of other parameters as optional. The graphical user interface 1002 can allow the individual 108 to use the drops down menus to select values of corresponding parameters from respective drop-down lists. Each drop-down list can have any corresponding predetermined number of pre-populated values, from which the individual 108 can select at least one value. When the individual 108 clicks on the arrow in the drop-down menu for specifying skin-tone, the graphical user interface 1002 can display a palette of continuously changing plurality of colors (for example, 256 colors). Although the graphical user interface 1002 is described as allowing the individual 108 to select values of parameters from pre-populated drop-down lists, in some another implementations, the graphical user interface can allow the individual 108 to specify customized values of the parameters in blank spaces.

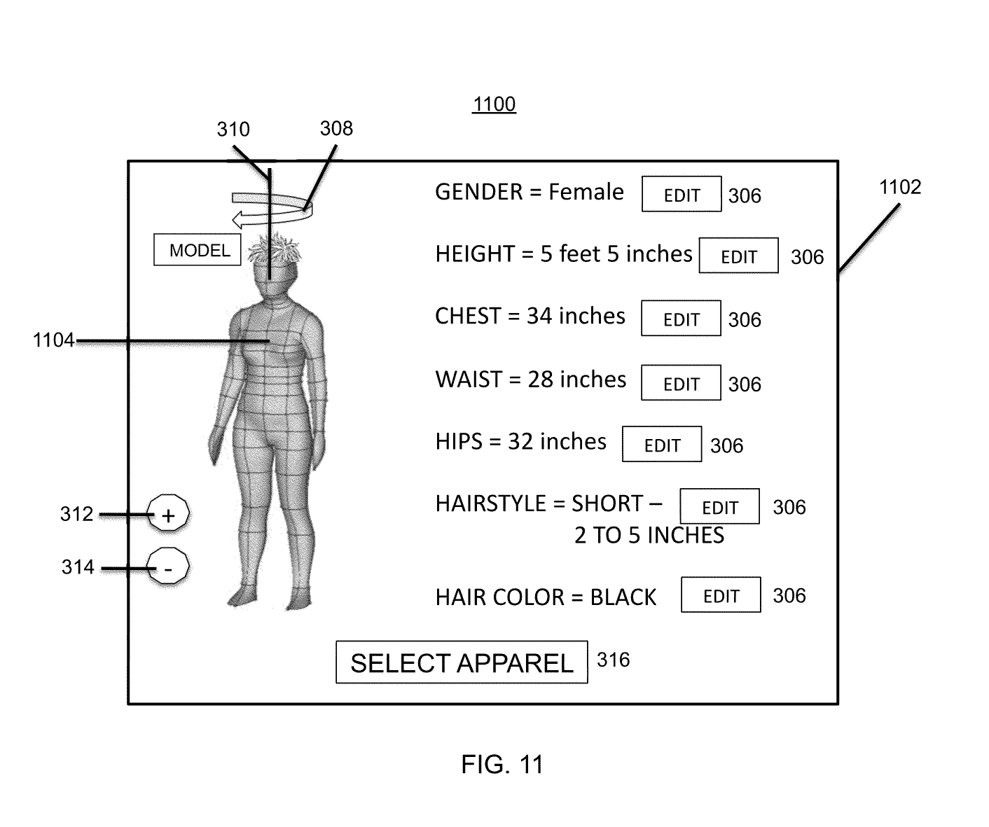

FIG. 11 is a diagram 1100 illustrating a graphical user interface 1102 executed by the virtual fitting room application 102 to display a three-dimensional model 1104 generated based on values of parameters specified by the individual 108 on graphical user interface 1002. The three-dimensional model 1104 can be generated based on operations described above with respect to flow-diagrams 700 and 800. The graphical user interface 1102 can display the values of the parameters, which can be selected by the individual 108 by using at least some of the drop-down menus of graphical user interface 1002. The graphical user interface 1102 can further include edit buttons 306. When the individual 108 selects the edit button 306 and provides a new value of the associated parameter, the three-dimensional model 1104 can be modified (for example, refined again by varying specific lines of the three-dimensional mesh associated with the three-dimensional model 1104) based on the edited value of the parameter. In other implementations, the three-dimensional model 1104 can be regenerated when the individual 108 selects the edit button 306 and provides a new value of the associated parameter.

In some implementations, the graphical user interface 1102 can allow the individual 108 to graphically modify the three-dimensional model 1104 by directly changing boundaries of the three-dimensional model 1104 by using a graphical drawing tool, such as a graphical pencil or a stylus optionally provided by the graphical user interface 1102. The three-dimensional model 1104 can be modified in any rotation and scaling position of the three-dimensional model 1104.

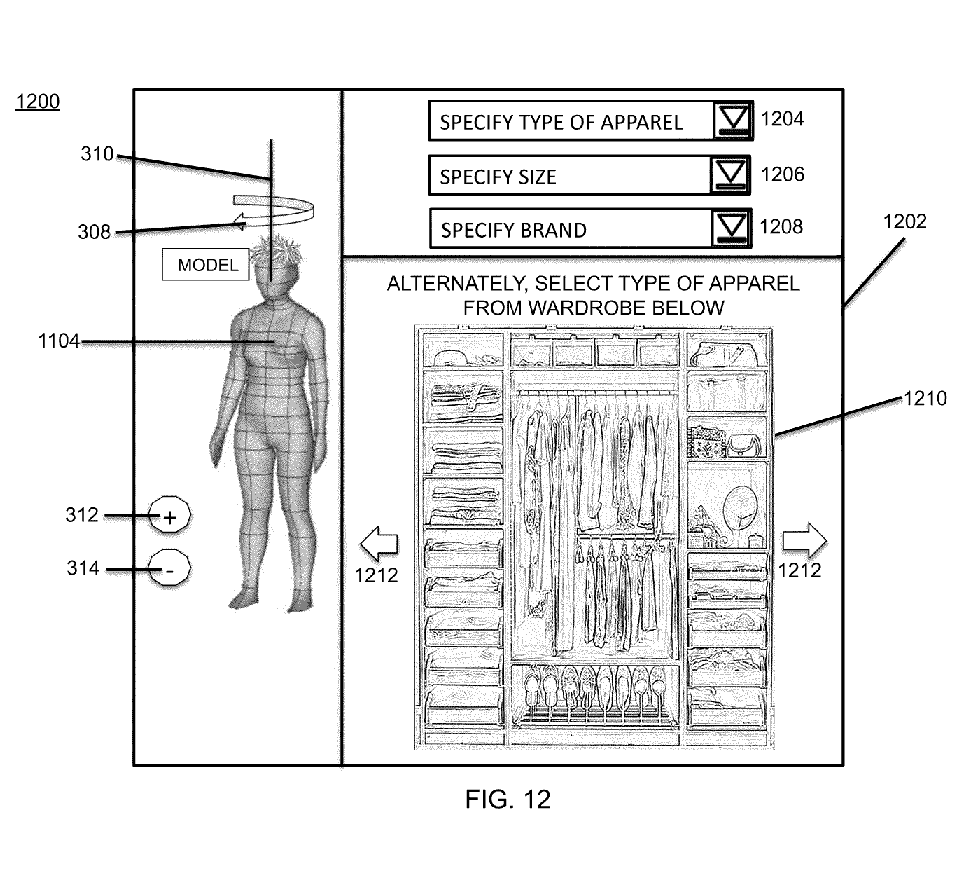

FIG. 12 is a diagram 1200 illustrating a graphical user interface 1202 executed by the virtual fitting room application 102 to allow the individual 108 to specify values for search criteria used for searching apparel. The search criteria can include at least one of type of apparel, size of apparel, brand of apparel, and any other relevant criteria. The graphical user interface 1202 can include a drop down menu 1204 that allows the individual 108 to select a type of apparel, a drop down menu 1206 that allows the individual 108 to select a size of apparel, and a drop down menu 1208 that allows the individual 108 to select a brand of apparel. In an alternate implementation, the graphical user interface 1202 can include blank spaces where the individual 108 can specify the type of apparel, the size of apparel, and the brand of apparel. The graphical user interface 1202 can further display a wardrobe 1210 that can display different types of clothes. The graphical user interface 1202 can allow the individual 108 to select one or more apparel from apparel displayed within the wardrobe 1210. The individual 108 may not be required to reselect the type of apparel using drop down menu 1204 when the individual 108 selects the apparel from the wardrobe 1210. The graphical user interface 1202 can include arrows 1212 that the individual 108 can click to view either other sections of the wardrobe 1210 or another wardrobe.

The type of apparel listed by the drop down menu 1204 can be at least one of: dresses, shirts, dress-shirts, t-shirts, pants, belts, footwear, gowns, undergarments, skirts, shorts, tank-tops, sweaters, cardigans, jackets, blazers, suits, tops, ethnic clothing, hats, headbands, wrist-bands, socks, sunglasses, jewelry, watches, sports-wear, and any other type of wearable items. The size of apparel listed by the drop down menu 1206 can have a range, such as zero to an upper limit (for example, twenty four), extra small to extra large, and/or any other possible range.

Once the individual 108 specifies values for the search criteria, the virtual fitting room application 102 can perform a search based on values of search criteria specified by the individual 108 on the graphical user interface 1202. To perform search, the virtual fitting room application 102 can obtain search results by searching data associated with apparel stored in a table, a list or any other format in the database 114. The data associated with apparel as stored in the database 114 can be data provided by various merchants selling the apparel. In an alternate implementation, the virtual fitting room application 102 can automatically crawl third party merchant websites over a communication network (for example, internet) to obtain search results, and then can index and rank the search results before displaying the search results. In some implementations, access to this communication network can be secure and can require the virtual fitting room access to provide authentication data (for example, a username and a password, or any other authentication data) to access the secure data in the communication network. After the virtual fitting room application 102 has performed the search, the virtual fitting room application 102 can execute another graphical user interface 1302 (described below) that can display the search results characterizing available apparel (for example, apparel that are currently available or will be available in near future) based on values of the search criteria specified by the individual 108 on the graphical user interface 1202.

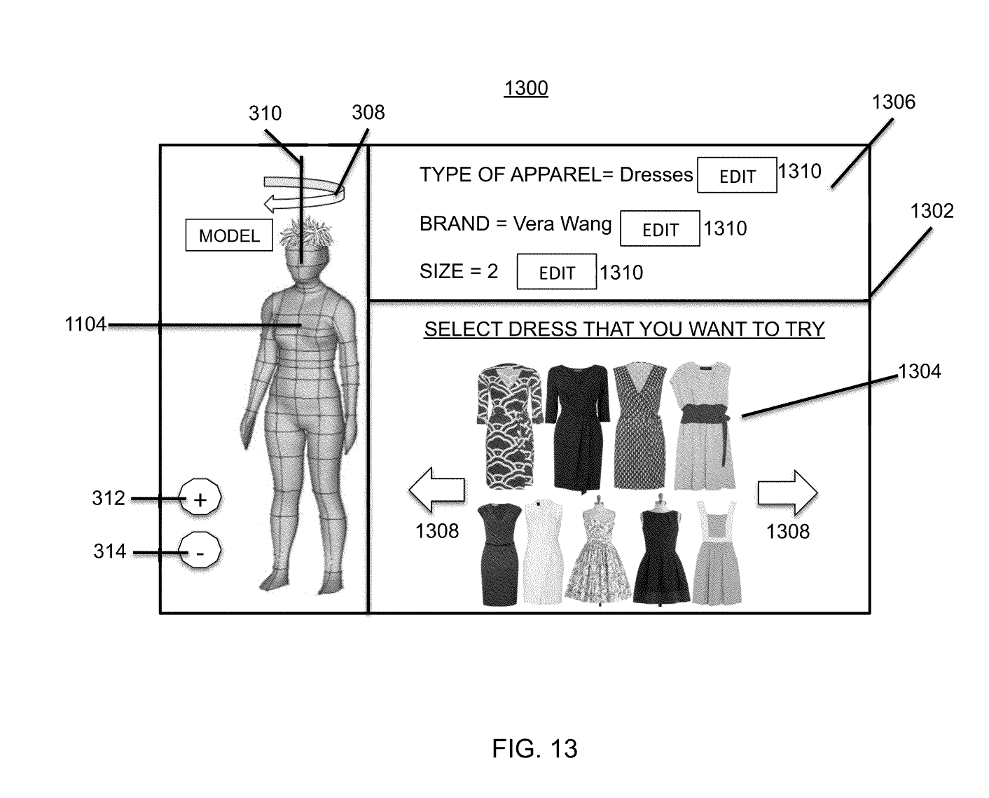

FIG. 13 is a diagram 1300 illustrating a graphical user interface 1302 executed by the virtual fitting room application 102 to display search results characterizing apparel 1304 that are searched and displayed based on values of search criteria 1306 specified by the individual 108. The graphical user interface 1302 can include arrows 1308 that the individual 108 can use to scroll through more apparel that has been found by the search. The graphical user interface 1302 can include arrows 1308 when all search results require more than the displayed graphical area for display of the apparel. The graphical user interface 1302 can allow the individual 108 to select any apparel from the displayed apparel 1304 that the individual 108 desires to try on the three-dimensional model 1104.

The graphical user interface 1302 can further include an edit button 1310 adjacent to at least one search result. The graphical user interface 1302 can allow the individual 108 to edit/modify any search criteria (for example, type of apparel, brand of apparel, and size of apparel) by clicking the edit button 1310. When the individual 108 edits/modifies a search criteria, the virtual fitting room application can perform a new search based on modified search criteria and replace the search results 1304 by modified search results in real-time (that is, within minimal or no delay since the individual 108 edits/modifies the search criteria).

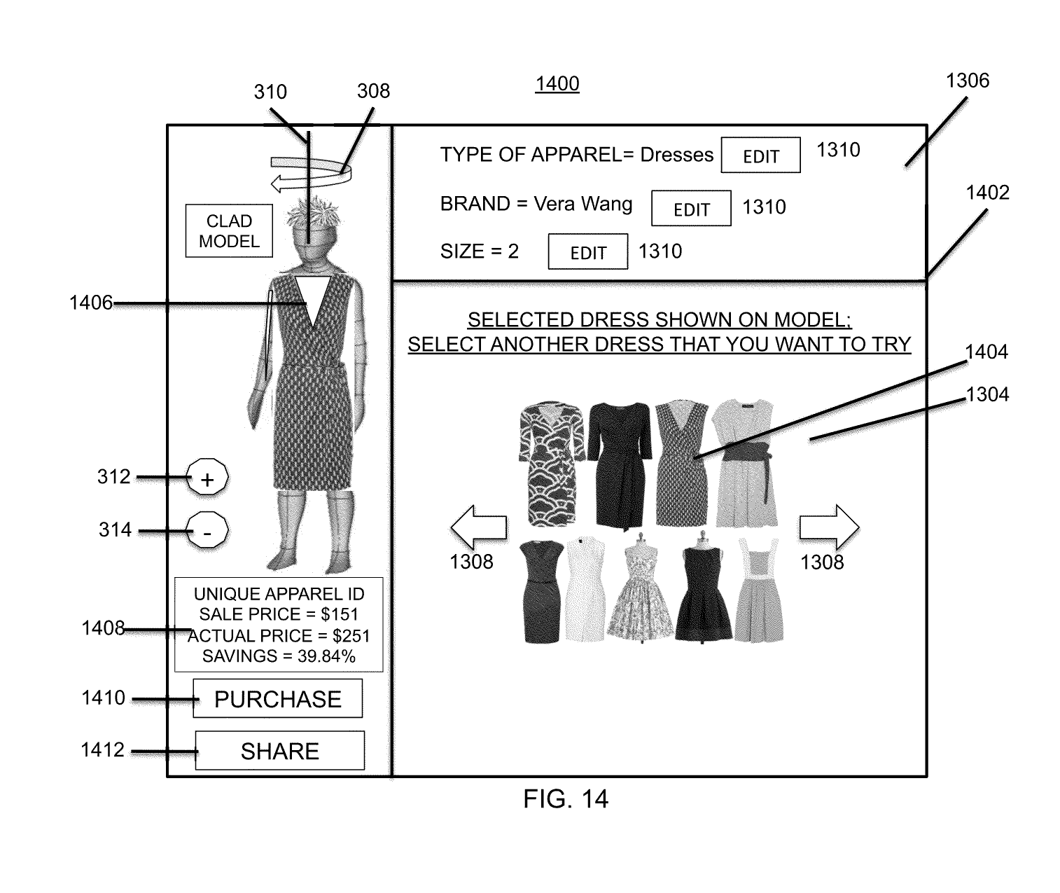

FIG. 14 is a diagram 1400 illustrating a graphical user interface 1402 executed by the virtual fitting room application 102 to try on selected apparel on the graphical three-dimensional model 1104. When the individual 108 selects a particular apparel, such as apparel 1404, from the apparel 1304 characterizing the search results, the virtual fitting room application 102 can fit the selected apparel 1404 on the three-dimensional model 1104 to generate a clad three-dimensional model 1406. The fitting of selected apparel 1404 on the three-dimensional model 1104 to generate the clad three-dimensional model 1406 is described below with respect to flow-diagram 1500. The graphical user interface 1402 can further include a data area 1408 that displays data associated with the selected apparel 1404. This data can include a unique apparel identifier (ID) uniquely identifying the selected apparel 1404, a sale price of the selected apparel 1404, actual price of the selected apparel 1404, and a percentage savings that the individual 108 can obtain by purchasing the selected apparel 1404. The graphical user interface 1402 can further include a purchase button 1410 that the individual 108 can click to purchase the selected dress 108.

Further, the graphical user interface 1402 can further include a share button 1412 that the individual 108 can click to share a web-link (for example, a link to a website executing the virtual fitting room application 102) to the three-dimensional model 1406 purchase the selected dress 1404. When the individual 108 clicks the share button 1412, the virtual fitting room application 102 can allow the individual 108 to share a web-link to the clad three-dimensional model 1406 with one or more other individuals via one or more of: at least one email; at least one blog; an internal computing site of a company; one or more social networks, such as FACEBOOK, LINKEDIN, TWITTER, MYSPACE, and any other social network; and any publishing computing location. In some alternate implementations, the virtual fitting room application 102 can allow sharing of the clad three-dimensional model 1406.

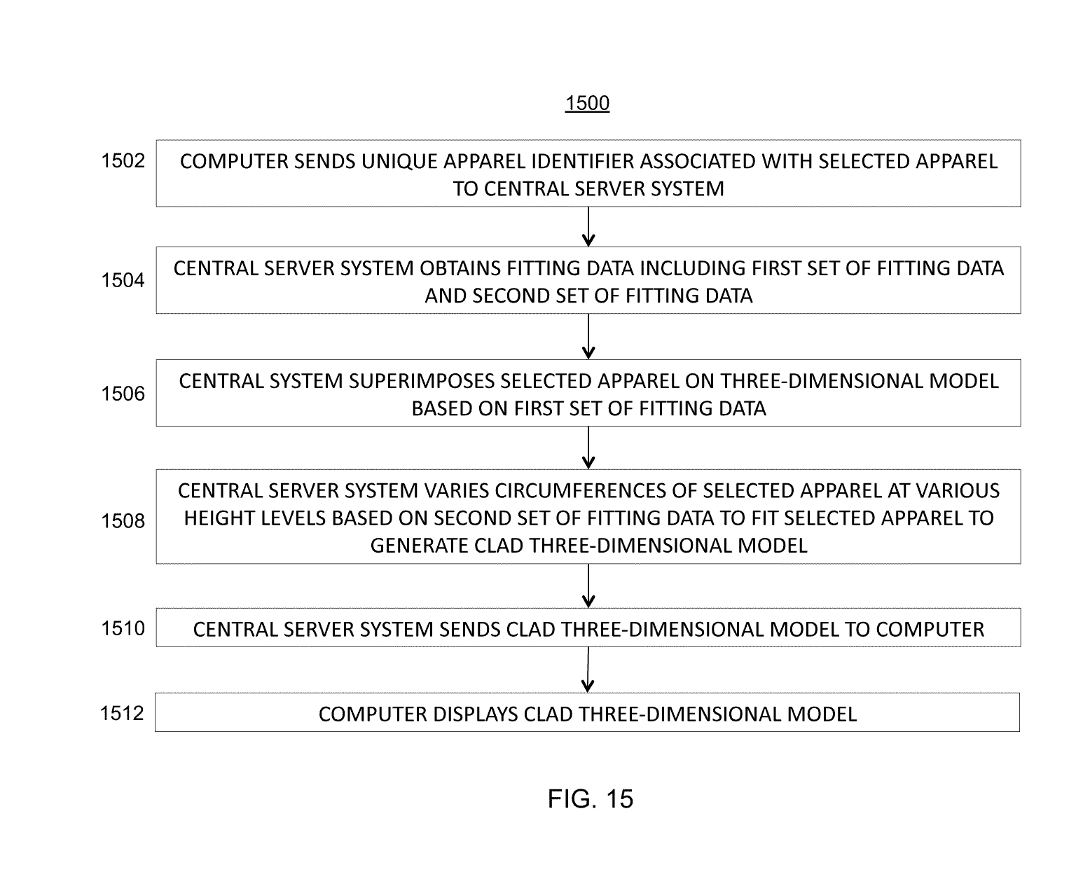

FIG. 15 is a flow-diagram illustrating a fitting of a selected apparel 1404 on the three-dimensional model 1104 to generate a clad three-dimensional model 1406. The computer 104 can send, at 1502, a unique apparel identifier uniquely identifying the selected apparel 1404 to the central server system 112 via the communication network 110.

The central server system 112 can obtain, at 1504 and from the database 114 or by crawling the Internet, fitting data associated with the selected apparel 1404 from the database 114. The fitting data associated with the selected apparel 1404 can include at least one of: gender for which the selected apparel 1404 is made, height of the selected apparel 1404 at one or more points along the circumference, width of the selected apparel 1404 at one or more height levels, size (for example, circumference) of the selected apparel 1404 at the chest portion, size (for example, circumference) of the selected apparel at the waist portion, size (for example, circumference) of the selected apparel 1404 at the hips portion, size (for example, circumference) of the selected apparel 1404 at the tummy portion, size (for example, circumference) of the selected apparel 1404 at the neck portion, length of the arms of the selected apparel 1404, and any other fitting data.

The central server system 112 can then superimpose, at 1506 and based on a first set of the fitting data obtained from the database 114, the selected apparel 1404 on the three-dimensional model 1104. The first set of the fitting data can include basic fitting data that indicates a shape of the selected apparel. This basic fitting data can include a height of the dress at various points around the circumference of the selected apparel 1404, a width of the selected apparel 1404, and length of the arms of the selected apparel 1404.

The central server system 112 can subsequently vary, at 1508, the dimensions and/or circumferences of the digitally superimposed apparel at various portions around the apparel based on a second set of the fitting data to generate the clad three-dimensional model 1406. The second set of fitting data can include fitting data that is used for a fit specific to the three-dimensional model 1104. This second set of fitting data can include size (for example, circumference) of the selected apparel 1404 at the chest portion, size (for example, circumference) of the selected apparel at the waist portion, size (for example, circumference) of the selected apparel 1404 at the hips portion, size (for example, circumference) of the selected apparel 1404 at the tummy portion, size (for example, circumference) of the selected apparel 1404 at the neck portion, and any other fitting data.

The central server system 112 can then send, at 1510, the clad three-dimensional model 1406 to the computer 104. The virtual fitting room application 102 that is being executed by the computer 104 can display, at 1512 and in real time (that is, with minimal or no lag time since the individual 108 selects the apparel 1404), the clad three-dimensional model 1406 on the user interface device 106.

In an alternate implementation, one or data processors and memory within the computer 104 can perform the functions of the central server system 112 and the database 114.

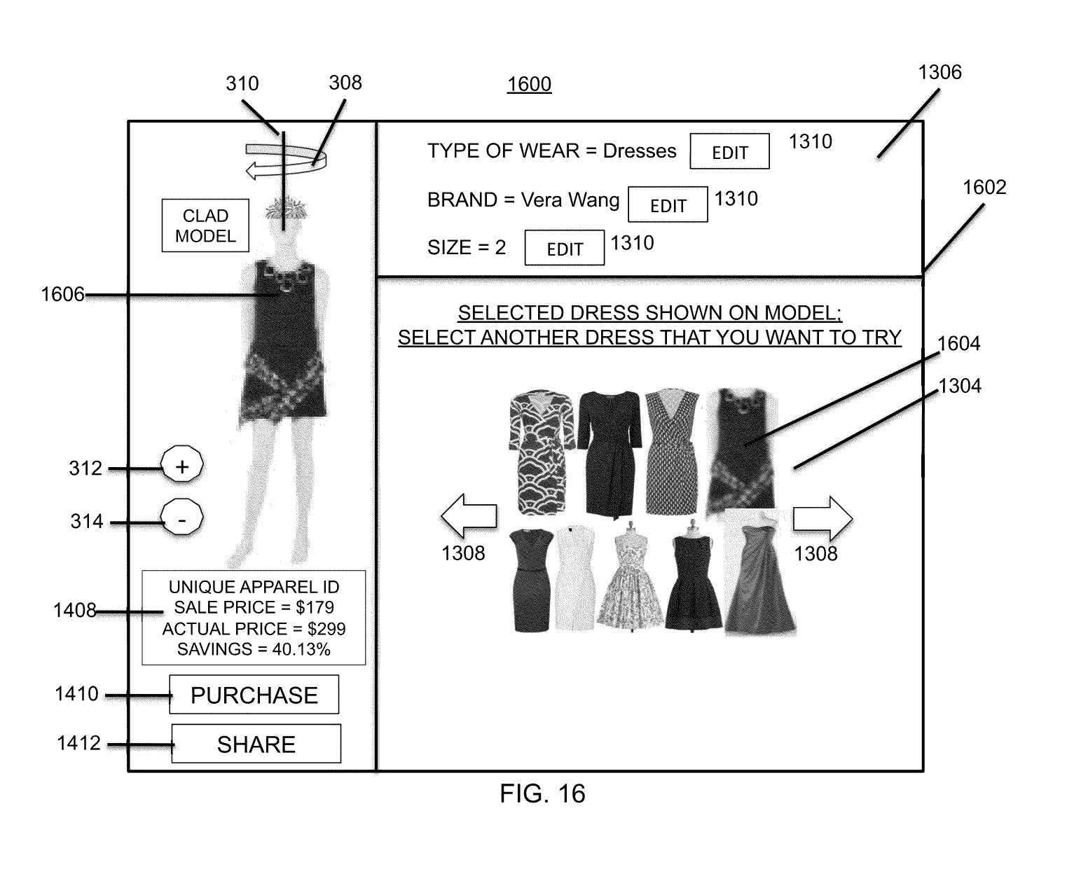

FIG. 16 is a diagram 1600 illustrating a graphical user interface 1602 executed by the virtual fitting room application 102 to try on another selected apparel 1604 on the graphical three-dimensional model 1104. When the individual 108 clicks the arrows 1308, the graphical user interface 1602 can display more search results represented by apparel 1304. These more search results can include the apparel 1604. When the individual 108 selects the apparel 1604, the virtual fitting room application 102 can remove the previously selected apparel from the three-dimensional model 1104 and can fit the selected apparel 1604 on the three-dimensional model 1104 to generate another clad three-dimensional model 1606. The selected apparel 1604 can be fitted on the three-dimensional model 1104 to generate the clad three-dimensional model 1606 in accordance with operations similar to those noted with respect to flow-diagram 1500. The illustrated model 1104 underlying clad model 1606 can be different from model 1104 of some other diagrams only when the three-dimensional model is changed by the individual 108 by editing some of the parameters on one of graphical user interface 302, graphical user interface 402, and graphical user interface 1102.

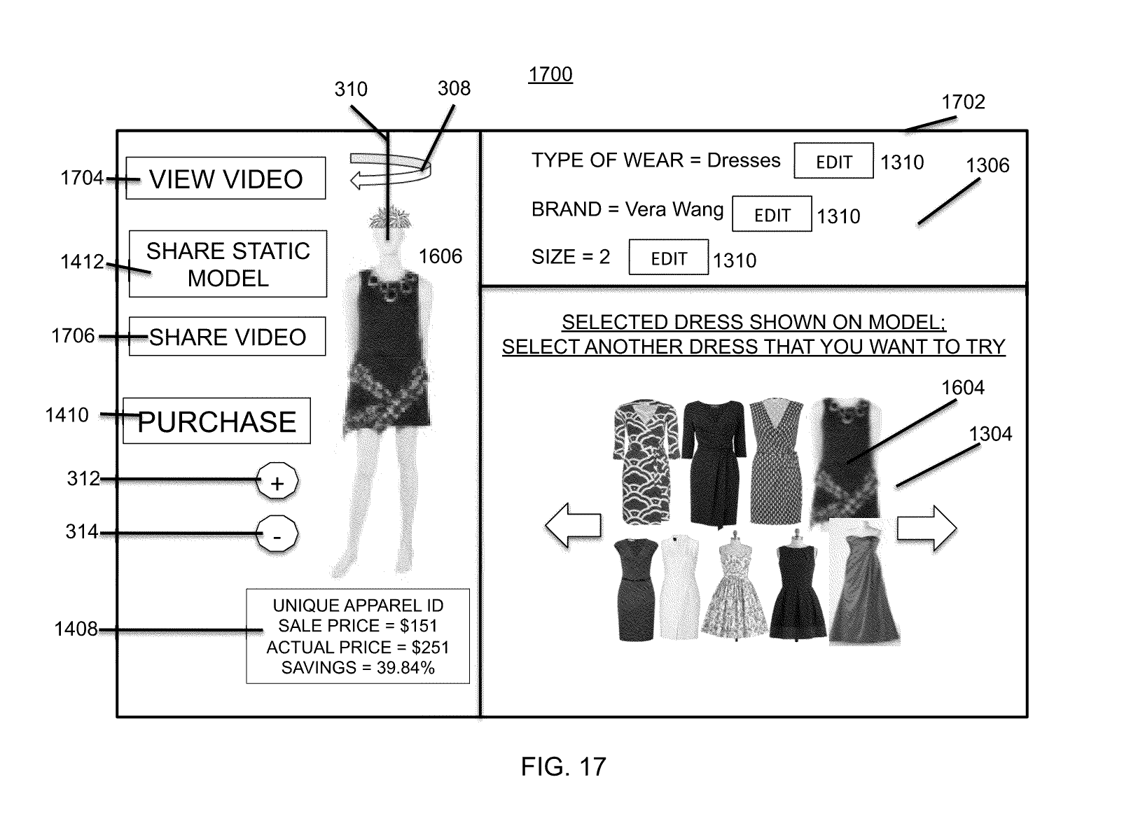

FIG. 17 is a diagram 1700 illustrating a graphical user interface 1702 that provides a button 1704, which, when clicked, displays a video of the clad three-dimensional model 1606. The virtual fitting room application 102 can execute the graphical user interface 1702. The video can include a motion/movement (for example, a turning, walking, running, sitting, standing, and/or stretching movement) of the clad three-dimensional model 1606 in different directions such that the individual 108 can view at least a fall and look of the selected apparel 1604 during a motion of a wearer. The virtual fitting room application 102 can generate the video of the clad three-dimensional model 1606 by using one or more flexible body animation techniques.

The graphical user interface 1702 can include a share video button 1706. When the individual 108 clicks the share video button, the virtual fitting room application 102 can allow the individual 108 to share a web-link to the video of the clad three-dimensional model 1606 with one or more other individuals via one or more of: at least one email; at least one blog; an internal computing site of a company; one or more social networks, such as FACEBOOK, LINKEDIN, TWITTER, MYSPACE, and/or any other social network; and any publishing computing location. In some alternate implementations, the virtual fitting room application 102 can allow sharing of a video file including the video of the clad three-dimensional model 1606.

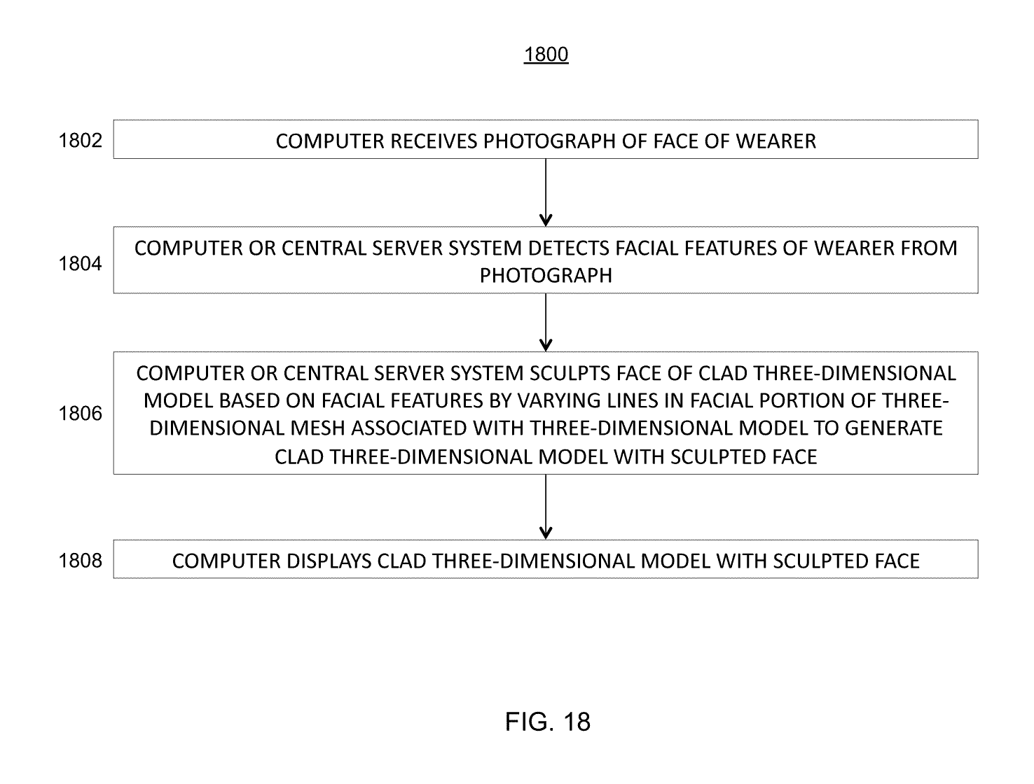

FIG. 18 is a flow-diagram 1800 illustrating a method of displaying a clad three-dimensional model having a face that is sculpted in accordance with facial features of a wearer of the selected apparel 1404 or 1604. The computer 104 can receive, at 1802, a photograph of the wearer that shows at least a face of the wearer. In one implementation, the individual 108 can upload an existing photo of the wearer to the computer 104. In another implementation, the wearer can be the individual 108, and a camera attached to or embedded within the computer 104 can be used to click a photo of the individual 108.

Then, one of the central server system 112 (in accordance with the implementation of diagram 100) and the computer 104 (in accordance with the alternate implementation of diagram 900) can detect, at 1804, facial features of the wearer from the photograph.

Subsequently, one of the central server system 112 (in accordance with the implementation of diagram 100) and the computer 104 (in accordance with the alternate implementation of diagram 900) can sculpt, at 1806, face of clad three-dimensional model 1406 or 1606 by varying at least some lines in facial portion of three-dimensional mesh 602 to generate a clad three-dimensional model with sculpted face.

The computer 104 can then display the clad three-dimensional model with the sculpted face on a graphical user interface (for example, on the graphical user interface 1702 in place of the clad three-dimensional model 1606). The graphical user interface can allow the rotation and movement of the clad three-dimensional model with the sculpted face, as allowed for the clad three-dimensional model 1406 or 1606. The sculpted face on the clad three-dimensional model 1406 or 1606 can advantageously make the individual 108 more comfortable with using the three-dimensional model for purchasing apparel.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user (for example, the individual 108), the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, Internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

What is claimed is:

1. A method comprising:
receiving, at a user interface device of a computer, values of a plurality of parameters characterizing dimensions associated with corresponding portions of a body, the values of the plurality of parameters being used by a server system connected to the computer to generate a graphical three-dimensional model specific to the body;
receiving, at the user interface device, data identifying an apparel selected from a plurality of apparel, the data identifying the apparel being used by the server system to fit the apparel on the graphical three-dimensional model to generate a clad three-dimensional model; and
displaying, on the user interface device, the clad three-dimensional model.

2. The method of claim 1, wherein the plurality of parameters includes two or more of: gender, height, size of chest, size of waist, size of hips, skin-tone, color of hair, style of hair, size of tummy, circumference of neck, length from shoulder to wrist, length from shoulder to elbow, length from elbow to wrist, length from hips to feet, length from hips to knees, length from knees to feet, length of left foot, length of right foot, width of left foot, and width of right foot.

3. The method of claim 1, wherein:
the computer is connected to the server system via a communication network; and
the communication network is internet.

4. The method of claim 1, wherein the generating of the graphical three-dimensional model comprises:
obtaining, by the server system, a three-dimensional mesh characterizing a basic structure of a human body; and
modifying, by the server system and based on the values of the plurality of parameters, paths of at least a few lines of the three-dimensional mesh to generate a refined three-dimensional mesh characterizing the graphical three-dimensional model.

5. The method of claim 1, further comprising:
displaying, by the user interface device, the plurality of apparel, the selected apparel being selected from the plurality of displayed plurality of apparel.

6. The method of claim 1, wherein the generating of the clad three-dimensional model comprises:
graphically superimposing, by the server system and based on a first set of fitting data associated with the selected apparel, the selected apparel on the graphical three-dimensional model; and
modifying, by the server system and based on a second set of fitting data associated with the selected apparel, paths of one or more lines of a refined three-dimensional mesh characterizing the graphical three-dimensional model to shapely-fit the selected apparel on the graphical three-dimensional model to generate the clad three-dimensional model.

7. The method of claim 6, wherein:
the first set of fitting data comprises basic fitting data that indicates a shape of the selected apparel; and
the second set of fitting data comprises fitting data that is used for a shapely fit specific to the graphical three-dimensional model.

8. A non-transitory computer program product storing instructions that, when executed by at least one programmable processor, cause the at least one programmable processor to perform operations comprising:
receiving, at a user interface device of a computer, values of a plurality of parameters characterizing dimensions associated with corresponding portions of a body, the values of the plurality of parameters being used by a server system connected to the computer to generate a graphical three-dimensional model specific to the body;
receiving, at the user interface device, data identifying an apparel selected from a plurality of apparel, the data identifying the apparel being used by the server system to fit the apparel on the graphical three-dimensional model to generate a clad three-dimensional model; and
displaying, on the user interface device and in real-time, the clad three-dimensional model.

9. The non-transitory computer program product of claim 8, wherein the operations further comprise:
receiving, at the user interface device, an input to rotate the graphical three-dimensional model along a displayed axis;
rotating, by one of the computer and the server system and based on the input, the graphical three-dimensional model along the displayed axis; and
displaying, on the user interface device, the rotated graphical three-dimensional model.

10. The non-transitory computer program product of claim 8, wherein the operations further comprise:
receiving, at the user interface device, an input to scale the graphical three-dimensional model;
scaling, by one of the computer and the server system and based on the input, the graphical three-dimensional model; and
displaying, on the user interface device, the scaled graphical three-dimensional model.

11. The non-transitory computer program product of claim 8, wherein the operations further comprise:
receiving, at the user interface device, an input to rotate the clad three-dimensional model along a displayed axis;
rotating, by one of the computer and the server system and based on the input, the clad three-dimensional model along the displayed axis; and
displaying, on the user interface device, the rotated clad three-dimensional model.

12. The non-transitory computer program product of claim 8, wherein the operations further comprise:
receiving, at the user interface device, an input to scale the clad three-dimensional model;
scaling, by one of the computer and the server system and based on the input, the clad three-dimensional model; and
displaying, on the user interface device, the clad graphical three-dimensional model.

13. The non-transitory computer program product of claim 8, wherein the operations further comprise:
receiving, at the user interface device, a selection of a video button displayed along with the clad three-dimensional model; and
displaying, by the user interface device, a video generated by the server system, the video characterizing a graphical movement of the clad-three dimensional model.

14. The non-transitory computer program product of claim 13, wherein the graphical movement of the clad-three-dimensional model characterizes at least one of a graphical walking and a graphical running of the clad-three-dimensional model.

15. The non-transitory computer program product of claim 8, wherein the operations further comprise:
receiving, by the computer, a photograph of an individual associated with the body, the photograph of the individual being used by the server system to digitally sculpt a face of the clad three-dimensional model; and
displaying, on the user interface device, the clad-three dimensional model with the sculpted face.

16. The non-transitory computer program product of claim 15, wherein the computer receives the photograph either when an individual using the computer uploads the photograph that is pre-stored in a memory device of the computer or when a camera embedded in the computer clicks the photograph of an individual using the computer.

17. The non-transitory computer program product of claim 15, wherein the sculpting of the face of the clad-three dimensional model comprises:
modifying, by the central computing system and based on a face in the photograph, paths of specific lines of a facial portion of a refined three-dimensional mesh characterizing the graphical three-dimensional model to generate the sculpted face

18. The non-transitory computer program product of claim 8, wherein the operations further comprise:
receiving, at the user interface device, a selection of a share button displayed along with the clad three-dimensional model; and
sharing, by the computer after the selection of the share button is received, the clad three-dimensional model via at least one of: at least one email, at least one blog, an internal computing site of a company, one or more social networks, and a publishing location on internet.

19. A system comprising:
at least one programmable processor; and
a machine-readable medium storing instructions that, when executed by the at least one processor, cause the at least one programmable processor to perform operations comprising:
receiving values of a plurality of parameters characterizing dimensions associated with corresponding portions of a body;
generating, based on the values of the plurality of parameters, a graphical three-dimensional model specific to the body;
receiving data identifying an apparel selected from a plurality of apparel;
fitting, using the data identifying the apparel, the apparel on the graphical three-dimensional model to generate a clad three-dimensional model; and
displaying, in real-time, the clad three-dimensional model and options to purchase the selected apparel.

20. The system of claim 19, wherein the plurality of parameters comprises: gender, height, size of chest, size of waist, and size of hips.
